(19) United States
(12) Patent Application Publication
(10) Pub. No.: US 2024/0222916 A1
(43) Pub. Date: Jul. 4, 2024

(54) COAXIAL CONNECTOR ASSEMBLY WITH AN IMPROVED TERMINAL

(71) Applicants: FOXCONN (KUNSHAN) COMPUTER CONNECTOR CO., LTD., San Jose, CA (US); FOXCONN INTERCONNECT TECHNOLOGY LIMITED, San Jose, CA (US)

(72) Inventors: WEI-TA TSENG, New Taipei (TW); Shih-Wei Hsiao, New Taipei (TW)

(73) Assignees: FOXCONN (KUNSHAN) COMPUTER CONNECTOR CO., LTD., San Jose, CA (US); FOXCONN INTERCONNECT TECHNOLOGY LIMITED, San Jose, CA (US)

(21) Appl. No.: 18/396,661

(22) Filed: Dec. 26, 2023

(30) Foreign Application Priority Data
Dec. 29, 2022 (CN) 202223540654.2

(51) Int. Cl. H01R 24/40; H01R 103/00

(52) U.S. Cl. CPC H01R 24/40; H01R 2103/00

(57) ABSTRACT

A coaxial connector assembly includes: a coaxial connector having an upper mating cavity, a lower mating cavity, and a center pin with a lower pin end extending in the lower mating cavity; and a coaxial socket adapted for being received in the lower mating cavity of the coaxial connector, the socket having: an insulating base having a mating face and a mating hole through the mating face and defining a central axis; and a terminal retained in the insulating base and having plural elastic arms with contacting portions extending into the mating hole for contacting with the lower pin end of the center pin, at least one of the contacting portions of the terminal being located nearer to the mating face than other contacting portions of the terminal.

### FIELD OF THE INVENTION

The present invention relates to an electrical connector assembly including a coaxial socket and a coaxial connector mating with each other.

### BACKGROUND OF THE INVENTION

U.S. Patent Application Publication No. 2023/0143493 discloses a coaxial connector including a case having an inserting opening, a terminal assembly received in the case and defining a mating opening facing the inserting opening of the case, and an elastic member disposed between the case and the terminal assembly. The elastic member provides elastic forces in a radial direction of the terminal assembly to keep the terminal assembly in a first position in a free state of the terminal assembly and pushes the terminal assembly to shift to a second position different from the first position in the radial direction in a mated state of the terminal assembly when the coaxial connector is mated with a complementary connector. But, when a larger shift of the case occurs, the connection between the center pin and the terminal assembly might be disabled.

An improved coaxial connector assembly is desired.

### SUMMARY OF THE INVENTION

The instant invention is to provide a coaxial connector assembly with an improved terminal.

To achieve the above-mentioned object, a coaxial connector assembly comprises: a coaxial connector having an upper mating cavity, a lower mating cavity, and a center pin with a lower pin end extending in the lower mating cavity; and a coaxial socket adapted for being received in the lower mating cavity of the coaxial connector and comprising: an insulating base having a mating face and a mating hole through the mating face and defining a central axis; and a terminal retained in the insulating base and comprising a plurality of elastic arms with contacting portions extending into the mating hole for contacting with the lower pin end of the center pin, at least one of the contacting portions of the terminal being located nearer to the mating face than other contacting portions of the terminal.

Other advantages and novel features of the invention will become more apparent from the following detailed description of the present embodiment when taken in conjunction with the accompanying drawings.

### BRIEF DESCRIPTION OF DRAWINGS

FIG. 1 is a top perspective view of a coaxial connector assembly in accordance with the present invention;

FIG. 2 is a bottom perspective view of the coaxial connector assembly in FIG. 1;

FIG. 3 is a cross-sectional view of the coaxial connector assembly taken along a broken line 3-3 in FIG. 1;

FIG. 4 is a cross-sectional view of the coaxial connector assembly taken along a broken line 4-4 in FIG. 1;

FIG. 5 is a top perspective view of a coaxial socket in FIG. 1;

FIG. 6 is a bottom perspective view of the coaxial socket in FIG. 1;

FIG. 7 is an exploded perspective view of the coaxial socket in FIG. 5;

FIG. 8 is an exploded perspective view of the coaxial socket in FIG. 6;

FIG. 9 is a cross-sectional view of a socket terminal taken along a broken line 9-9 in FIG. 7;

FIG. 10 is a cross-sectional view of the socket terminal taken along a broken line 10-10 in FIG. 7;

FIG. 11 is a top plan view of the socket terminal in FIG. 7;

FIG. 12 is a bottom perspective view of a coaxial connector in FIG. 1;

FIG. 13 is a top exploded perspective view of the coaxial connector in FIG. 12; and

FIG. 14 is a bottom perspective view of the coaxial connector in FIG. 12.

### DETAILED DESCRIPTION OF THE PREFERRED EMBODIMENT

Reference will now be made in detail to the preferred embodiments of the present invention.

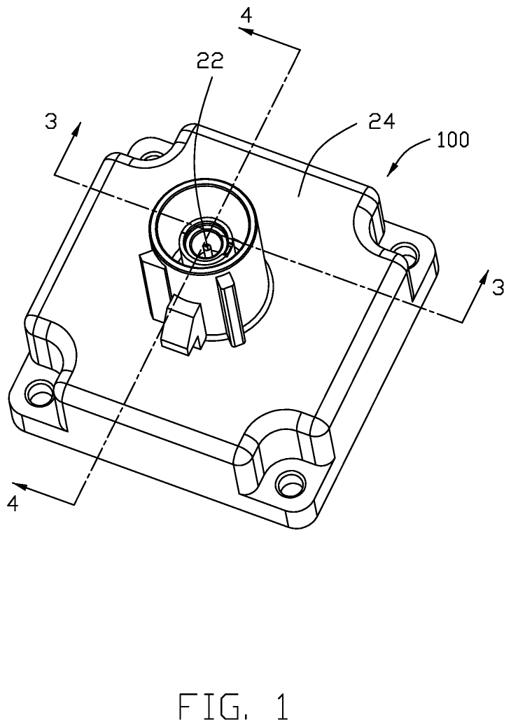

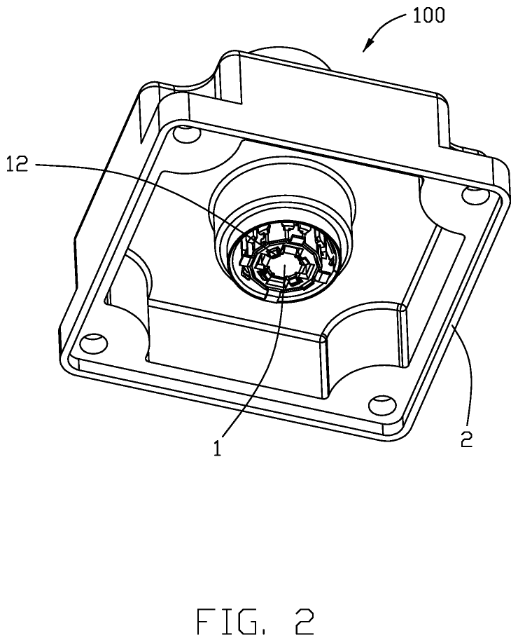

Referring to FIGS. 1-4, a coaxial connector assembly 100 is illustrated, which includes a coaxial electrical connector and a mating coaxial electrical connector. The coaxial electrical connector is adapted to be mounted on a circuit board 300, which is of a receptacle connector type or a coaxial socket 1. The mating coaxial electrical connector is of a pin coaxial connector 2, which defines a center pin 22 extending toward the circuit board 300. The circuit board 300 is mounted in the coaxial connector 2, the coaxial socket 1 is mated with the center pin 22 of the coaxial connector 2.

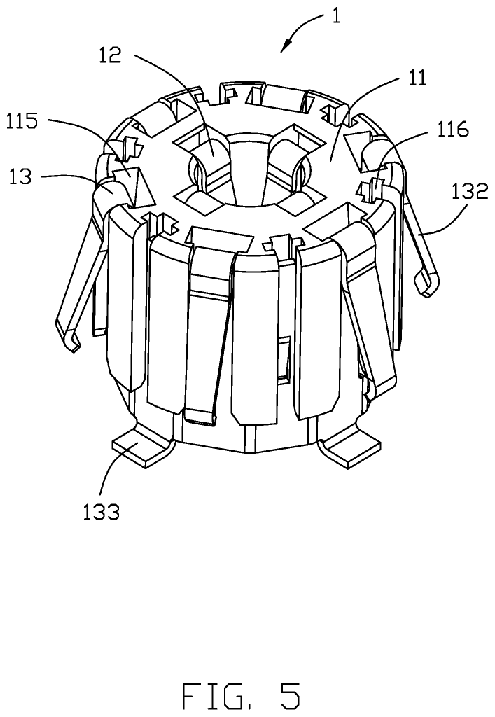

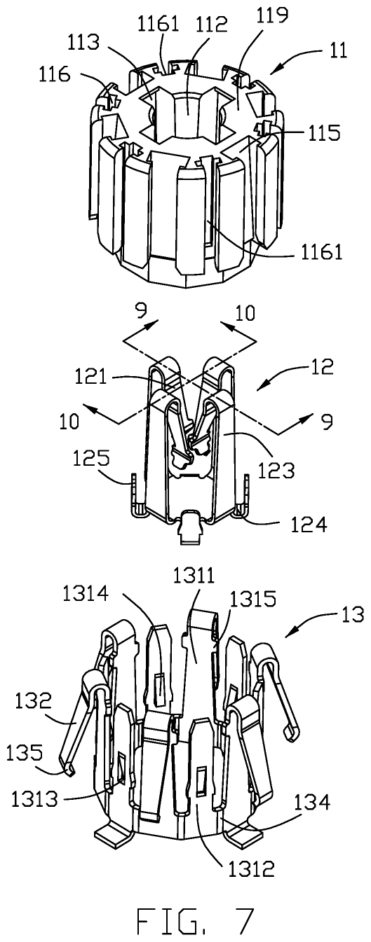

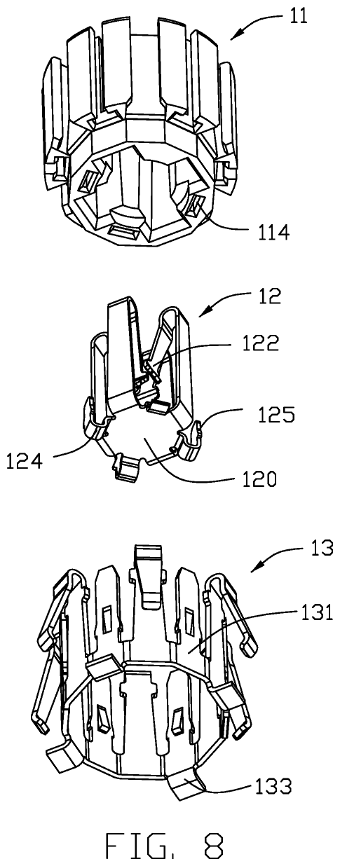

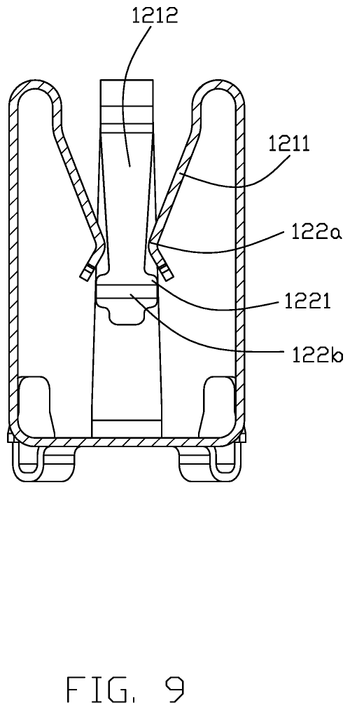

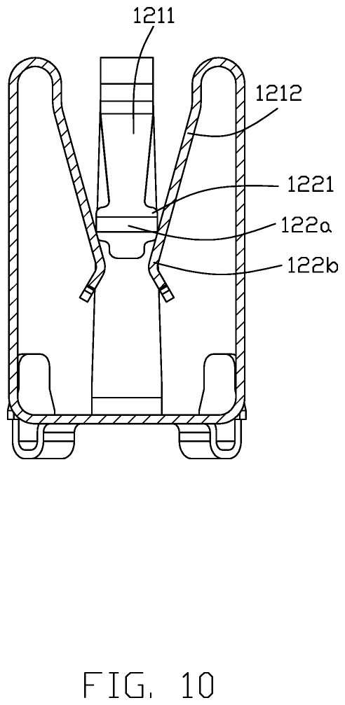

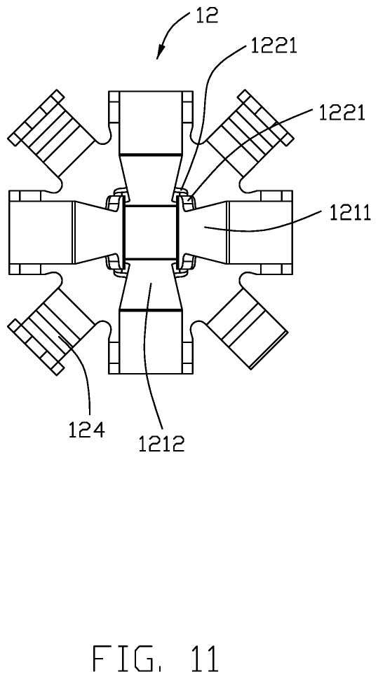

Referring to FIGS. 7-8, the coaxial socket 1 includes an insulating tube 11, a conductive terminal 12 in a form of socket terminal, and an elastic member 13. The insulating tube 11 includes a tube wall 111 defining a mating face 119, and a mating hole 112 defined in the tube wall 11 and running through the mating face 119. The terminal 12 is retained in the tube wall 111 as shown in FIG. 5, which includes a plurality of elastic arms 121 with arc-shape contacting portions 122 thereon. The elastic arms 121 extend towards the mating holes 112 and the contacting portions 122 protrude into the mating hole 112. The mating holes 112 defines a central axis thereof, in an upper-down direction in this embodiment, the elastic arms 121 are disposed around the central axis of the mating hole 112 in a circumferential direction, the contacting portions 122 bend towards the central axis of the mating hole 112. As shown in FIGS. 9-10, at least one of the contacting portions 122 is located with a height different from other contacting portions in the central axis. Viewed in a direction perpendicular to the mating face 129 as shown in FIG. 11, every two adjacent contacting portions 122 at least overlap partially.

Referring to FIGS. 9-11 again, the elastic arms 121 includes a pair of first elastic arms 1211 opposite to each other and a pair of second elastic arms 1212 opposite to each other, in this embodiment. The first and the second elastic arms are disposed in a staged pattern. The contacting portions 122b of the second elastic arms 1212 are located far from the mating face 119 than the contacting portions 122a of the first elastic arms 1211. Each of the contacting portion 122 defines two shoulder portions 1221 transversely protruding from opposite sides thereof in a direction perpendicular to the central axis, the shoulder portions 1221 of the adjacent elastic arms are located at different heights, please notes, the width of the elastic arms become small toward to the contacting portions 122, thereby avoiding interfere of adjacent elastic arms. The shoulder portions 1221 enlarge the width of the contacting portions 122a, 122b and make the contacting portions 122a, 122b are partially overlapped in the central axis.

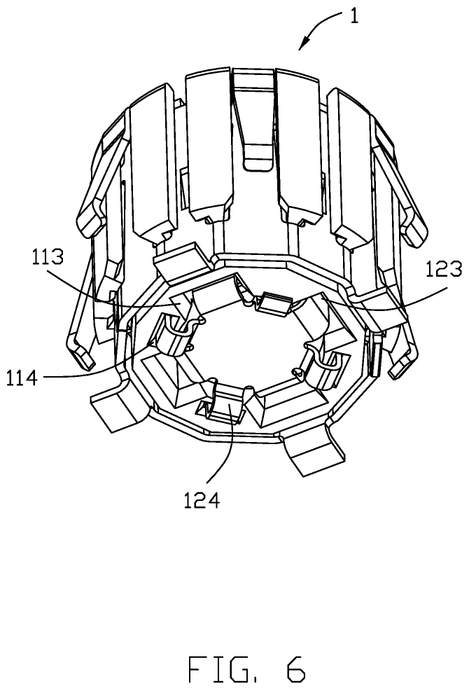

Referring to FIGS. 5-8, the terminal 12 includes a base portion 120, a plurality of upright portion 123 extending from the base portion 120 and the elastic arms 121 folded slantwise and inward from the top ends of the upright portions 123. The base portion 120 of the terminal is in a form of a disc bottom plate, the upright portions 123 extend from a circumferential edge of the bottom plate and a plurality of soldering portions 124 extend from the circumferential edge of the bottom plate. The soldering portion 124 is located between adjacent upright portions 123. A retained portion 125 with barbs extends upwards from corresponding soldering portion 124. The retained portions 125 are retained in the tube wall 112. The insulating tube 11 defines upright grooves 113 through the mating face 119 and the bottom face thereof at an inside face of the tube wall 112, the upright grooves 113 open through the inside face of the tube wall 112. The upright portions 123 are retained in the upright grooves 113. A retained groove 114 is defined between every two adjacent upright grooves 113, which recessed upwards from the bottom face of the insulating tube 11. As shown in FIG. 6, the retained portions 125 are retained in the retained grooves 114.

As shown in FIGS. 5-8, the elastic member 13 is retained at an outside of the insulating tube 11, which includes a plurality of upright retained portions 131, a plurality of third elastic arms 132 and a plurality of soldering portions 133. Some retained portions, named as first retained portion 1311 define barbs 1315 at opposite upper sides thereof, and the third elastic arms 132 fold outwards from the upper ends of the first retained portions 1311. Other retained portions, named as second retained portions 1312 each defines an opening 1313 and a tab 1314 in the opening 1313. The tube wall 11 defines first retained grooves 115 to receive the first retained portions 1311, second retained grooves 116 to receive the second retained portion 1312. The first and second retained grooves 115, 116 are recessed from the outside face of the tube wall 11 and run through the top face and the bottom face of the tube wall 11. Viewed from the bottom face of the insulating tube 11, the first and second retained grooves 115, 116 are of a T shape, the second retained groove 116 further defines a stopping groove 1161 recessed inward, viewed from the mating face 129, the second grooves 116 are of a cross shape. The stopping grooves 1161 run through the mating face 129 but not through the bottom face. The tabs 1314 extend downward to press against the stopping grooves 1161. The soldering portions 133 define soldering faces to be mounted on the circuit board 300.

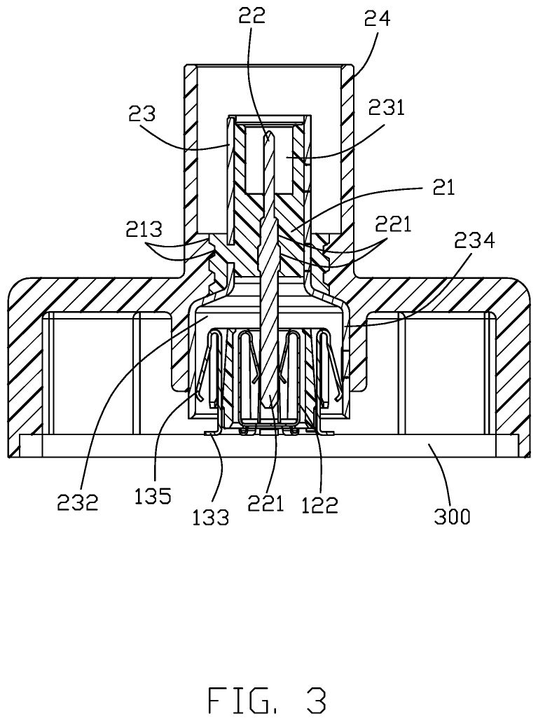

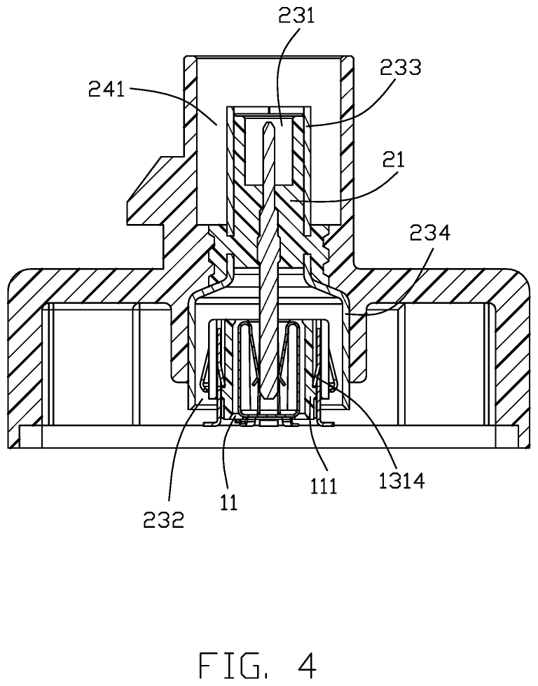

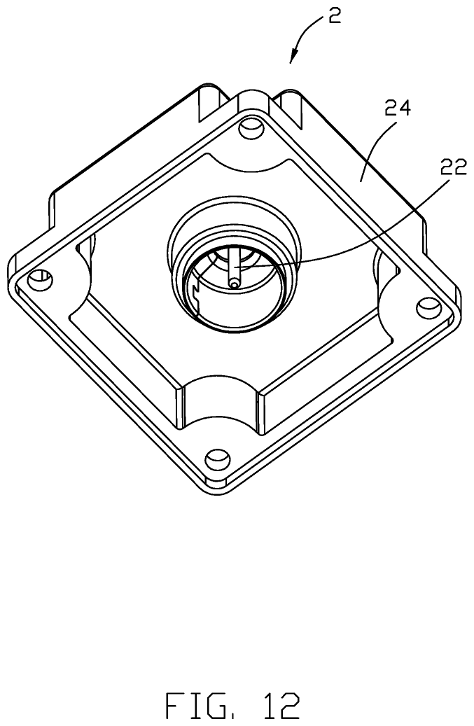

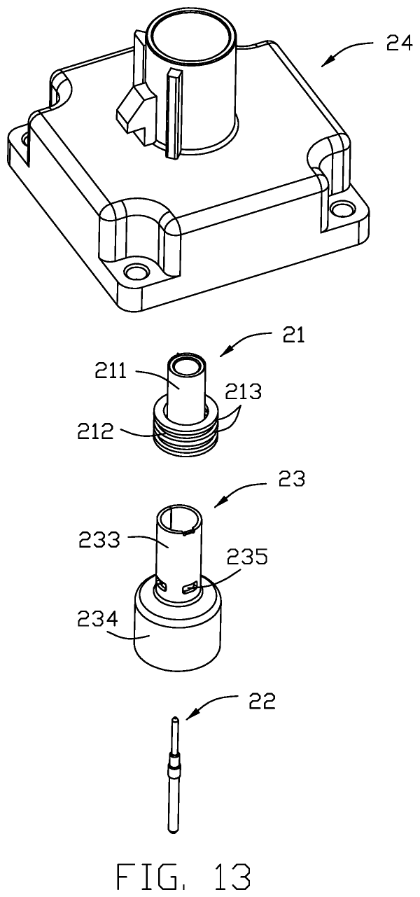

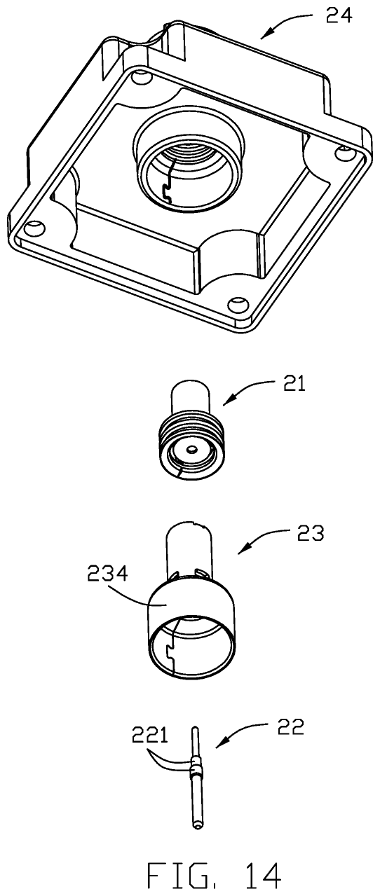

Referring to FIGS. 12-14, the coaxial connector 2 includes an insulating base 21, a center pin 22 retained in the insulating base 22 and a shielding tube 23 in which the insulating base 21 is retained. The shielding tube 23 retained with the insulating base 21 and the center pin 22 is retained in an insulating case 24. The shielding tube 23 includes an upper tube portion 233 and a lower tube portion 234 The insulating base 21 includes a first base 211 and a second base 212. Combination with FIGS. 3-4, the first base 211 is received the upper tube portion 233, and the second base 212 overflows through holes 235 defined at the upper tube portion 234 so that the second base 212 surrounds a lower end of the upper tube portion 233. Combination with FIGS. 3-4, saw-teeth 213 which are defined around the second base 212, are fitly retained with the insulating case 24, the center pin 22 defines step portions 221 at a middle thereof to ensure a retained connection of the center pin 22 with the insulating base 21.

In conjunction with FIGS. 3-4, the coaxial connector 2 defines an upper mating cavity 231 in which an upper pin end of the center pin 22 extends and a lower mating cavity 232 in which a lower pin end of the center pin 22. The upper mating cavity 231 is surrounded with the insulating base 21, the lower mating cavity 232 is surrounded with the lower tube portion 234. The insulating base 21, the center pin 22 and the shielding tube 23 is formed by an inserting molded process, and then is assembled in the insulating case 24. The insulating case 24 further defines an outer mating cavity 241 surrounding the upper tube portion 233. The coaxial socket 1 is received in the lower mating cavity 232, the lower pin end 221 of the center pin 22 are sandwiched with the contacting portions 122 of the terminal 12, thereof establishing an electrical connector of the terminal 12 and the center pin 22. The first contacting portion 122a and the second contacting portions 122b at different height ensure the electrical connection. The shoulder portions 1221 of the contacting portions 122 are offset but partially overlap in the upright direction, ensure the stable connection as aforementioned. The lower arc portions 135 of the third elastic arms 132 of the elastic member 13 abut against the inside of the shielding tube 23. After the coaxial socket 1 is inserted with the coaxial connector 2, the third elastic arms 132 press against the inside of the shielding tube 23 to balance the position of the coaxial socket 1. The center pin 22 of the coaxial connector 2 is inserted in the mating hole 112 and may push the coaxial socket 1 slightly shift, the shoulder portions 1221 keep contact with the center pin 22 so that the connection between the center pin 22 and at least three elastic arms 121 is ensured. After the center pin 22 is removed from the mating hole 112, the coaxial socket 1 returns to an original position by the third elastic arms 132.

Although the present invention has been described with reference to particular embodiments, it is not to be construed as being limited thereto. Various alterations and modifications can be made to the embodiments without in any way departing from the scope or spirit of the present invention as defined in the appended claims.

1. A coaxial connector assembly comprising:
a coaxial connector having an upper mating cavity, a lower mating cavity, and a center pin with a lower pin end extending in the lower mating cavity; and
a coaxial socket adapted for being received in the lower mating cavity of the coaxial connector, comprising:
an insulating base having a mating face and a mating hole through the mating face and defining a central axis; and
a terminal retained in the insulating base and comprising a plurality of elastic arms with contacting portions extending into the mating hole for contacting with the lower pin end of the center pin, at least one of the contacting portions of the terminal being located nearer to the mating face than other contacting portions of the terminal.

2. The coaxial connector assembly as claimed in claim 1, wherein the coaxial connector comprises an insulating case, a shielding tube retained in the insulating case, and an insulating base with the center pin retained therein, the insulating base comprises a first base retained in the shielding tube and a second base around an outside of the shielding tube, and the second base is fitly retained in the insulating case.

3. The coaxial connector assembly as claimed in claim 2, wherein the second base is formed by insulating material overflowing through plural holes defined on the shielding tube.

4. The coaxial connector assembly as claimed in claim 3, wherein the upper mating cavity is defined by the first base of the insulating base, and the second mating cavity is defined by the shielding tube.

5. The coaxial connector assembly as claimed in claim 4, wherein the insulating case further defines an outer upper mating cavity around the shielding tube.

6. The coaxial connector assembly as claimed in claim 1, wherein viewed from the mating face in the central axis, adjacent contacting portions partially overlap with each other.

7. The coaxial connector assembly as claimed in claim 1, wherein each of the contacting portions defines a pair of shoulder portions at opposite sides thereof, and the shoulder portions of adjacent contacting portions partially overlap with each other.

8. The coaxial connector assembly as claimed in claim 1, wherein the terminal comprises a base portion, a plurality of upright portions extending upward from the base portion, and a plurality of elastic arms folded slantwise from the upright portions.

9. The coaxial connector assembly as claimed in claim 1, wherein the plurality of elastic arms comprises a pair of first elastic arms opposite to each other and a pair second elastic arms opposite to each other, and the contacting portions of the first elastic arms are located nearer to the mating face than the contacting portions of the second elastic arms.

10. A coaxial socket comprising:
an insulating tube comprising a tube wall defining a mating face and a mating hole surrounding by the tube wall through the mating face; and
a terminal retained in the tube wall and comprising a plurality of elastic arms disposed around a central axis of the mating hole in a circumferential direction, each elastic arm defining a contacting portion bending towards the central axis of the mating hole;
wherein at least one contacting portion is located nearer to the mating face than adjacent contacting portions.

11. The coaxial socket as claimed in claim 10, wherein viewed from the mating face in the central axis of the mating hole, adjacent contacting portions partially overlap with each other.

12. The coaxial socket as claimed in claim 11, wherein the plurality of elastic arms is comprised of a pair of first elastic arms opposite to each other and a pair of second elastic arms opposite to each other, the contacting portions of the first elastic arms are located nearer to the mating face than the contacting portions of the second elastic arms.

13. The coaxial socket as claimed in claim 12, wherein each of the contacting portions defines a pair of shoulder portions at opposite sides thereof, and adjacent shoulder portions partially overlap with each other.

14. The coaxial socket as claimed in claim 13, wherein the terminal comprises a base portion and a plurality of upright portions extending upward from a circumferential edge of the base portion, and the elastic arms slantwise extend inward and downward from corresponding upright portions.

15. The coaxial socket as claimed in claim 14, wherein a plurality of soldering portions extend downward from the circumferential edge of the base portion and are located between two adjacent upright portions.

16. The coaxial socket as claimed in claim 15, wherein a plurality of retained portions bend upwards from corresponding soldering portions and are retained in the tube wall.

17. The coaxial socket as claimed in claim 10, further comprising an elastic member having a plurality of retained arms retained in the tube wall, a plurality of third elastic arms slant outwards, and a plurality of soldering portions extending downwards.
